(19) United States
(12) Patent Application Publication
(10) Pub. No.: US 2025/0255293 A1
(43) Pub. Date: Aug. 14, 2025

(54) TISSUE DECONTAMINATION AND PRESERVATION SYSTEM

(71) Applicant: The Curators of the University of Missouri, Columbia, MO (US)

(72) Inventors: James L. Cook, Columbia, MO (US); Aaron Stoker, Columbia, MO (US); Gregory J. Della Rocca, Columbia, MO (US); Julia Nuelle, Columbia, MO (US)

(21) Appl. No.: 19/050,638

(22) Filed: Feb. 11, 2025

Related U.S. Application Data
(60) Provisional application No. 63/552,399, filed on Feb. 12, 2024.

(51) Int. Cl. A01N 1/124; A01N 1/126; A01N 1/162

(52) U.S. Cl. CPC A01N 1/124; A01N 1/126; A01N 1/162

(57) ABSTRACT

The present invention provides methods and compositions for decontamination and preservation osteochondral tissue, such as an osteoarticular fracture fragment, meniscus, meniscal tissue, cartilage or other component of a joint or bone tissue fragment autograft, for extended periods of time at room temperature in a tissue storage container or bag. The invention further provides a process for maintaining the sterility of the osteochondral tissue using the apparatus as described.

### CROSS REFERENCE TO RELATED APPLICATIONS

This application claims the benefit under 35 U.S.C. § 119(e) of U.S. provisional application Ser. No. 63/552,399, filed on Feb. 12, 2024, which is herein incorporated by reference in its entirety.

### FIELD OF THE INVENTION

The invention relates to the field of tissue, such as an autograft, decontamination and storage and more specifically to the field of tissue decontamination and preservation.

### BACKGROUND OF THE INVENTION

Autograft or other tissues such as allografts are used to treat many diseases and/or defects. While allografts are procured from organ donors and must be stored to allow for viral and bacterial testing for safety prior to shipping to surgical centers for implantation into patients, autografts are typically reimplanted in the patient during the same operative session as harvest. However, if the tissues to be used as autografts are contaminated due to trauma, or other causes, decontamination is necessary prior to reimplantation, which may be delayed to another operative session to ensure effective decontamination. If delayed, preservation of autograft tissue viability during storage before reimplantation must be considered.

Open articular fractures pose a challenge for orthopedic surgeons. Anatomic reconstruction with autogenous cartilage and bone provides the most consistently successful outcomes; therefore, retention of osteoarticular fracture fragments is desirable. However, these fragments are often contaminated, devascularized, and/or extruded, making immediate reimplantation rarely successful. Current recommendations, therefore, are to discard these compromised osteoarticular fracture fragments and opt for other inferior methods for reconstruction or shift to less desirable options including arthroplasty, arthrodesis or amputation. This lack of ability to use compromised osteoarticular fracture fragments in these cases is related to difficulty in achieving a safe and effective balance between disinfection and preservation of viability. As such, functional joint reconstruction is not be possible in a significant number of these cases. Therefore, a reliable method for disinfection and preservation of osteoarticular fracture fragments for delayed re-implantation (osteochondral autograft) is needed, and would represent a significant advance in the field.

### SUMMARY OF THE INVENTION

Briefly described, embodiments of this disclosure provide methods and compositions for tissue decontamination and preservation. Specifically, this disclosure provide methods and compositions for osteochondral tissue decontamination and preservation. As used herein, the term “osteochondral tissue” includes osteoarticular fracture fragments, meniscus, meniscal tissue, cartilage and any other components of a joint or bone tissue fragment.

The present disclosure provides a process for decontamination and preservation of osteochondral tissue, such as osteoarticular fracture fragments, meniscus or meniscal tissue, comprising contacting the osteochondral tissue with chlorhexidine, providone-iodine, an iodophor, octenidine dihydrochloride or polyhexanide, and then storing the osteochondral tissue at room temperature in a tissue storage container or bag comprising serum-free culture medium for from at least 7 to 70 days prior to implantation, wherein at least 70% of the cells of said osteochondral tissue remains viable after said storing compared to the viability of the cells of the osteochondral tissue at day 0. In certain embodiments the method comprises testing the osteochondral tissue for viability at least once prior to implantation in a patient. In some embodiments testing for viability comprises assaying the medium withdrawn from said container. In other embodiments testing for viability comprises adding a resazurin solution to the medium and determining the fluorescence level, wherein increased fluorescence indicates higher cell viability.

In particular embodiments the process comprises changing said medium at least once during the storing. In other embodiments the process comprises changing the medium about once every two weeks during the storing. In certain embodiments the medium comprises Dulbecco's Modified Eagle Medium (DMEM), insulin, transferrin, selenium, at least a first antibiotic compound, at least a first antimycotic compound, L-glutamine, non-essential amino acids, ascorbic acid, and dexamethasone. In some embodiments the at least a first antibiotic compound comprises penicillin and streptomycin. In yet other embodiments the at least a first antimycotic compound is amphotericin B. In various embodiments the osteochondral tissue is from a humerus, radius, ulna, femur, tibia, fibula, spine, scapula, pelvis, patella, talus, phalanges or temporomandibular joint.

In further embodiments the osteochondral tissue comprises an autograft. In other embodiments the osteochondral tissue comprises an autograft, the process further comprising lavaging of the osteochondral tissue in isotonic solution prior to said storing. In some embodiments the process further comprises implanting the osteochondral tissue in a subject in need thereof following said storing.

In certain embodiments the room temperature is between about 19° C. and 27° C. In other embodiments the room temperature is about 19° C., 20° C., 21° C., 22° C., 23° C., 24° C., 25° C., 26° C., or about 26° C. In particular embodiments the osteochondral tissue is contacted with chlorhexidine for between about 5 minutes and about 60 minutes. In yet other embodiments the osteochondral tissue is contacted with chlorhexidine for about 20 minutes. In some embodiments the osteochondral tissue is contacted with about 0.0005%, 0.001%, 0.002%, 0.003%, 0.004%, 0.005%, 0.006%, 0.007%, 0.008%, 0.009%, 0.01%, or 0.02% chlorhexidine. In various embodiments the osteochondral tissue is contacted with about 0.002% chlorhexidine.

The present disclosure also provides a method for decontaminating and preserving osteochondral tissue, such as osteoarticular fracture fragments, meniscus or meniscal tissue, comprising contacting the osteochondral tissue with chlorhexidine, providone-iodine, an iodophor, octenidine dihydrochloride or polyhexanide, and placing the osteochondral tissue in a tissue storage container or bag with serum-free culture medium; and storing the osteochondral tissue at room temperature for at least 7 to 70 days prior to implantation, wherein at least 70% of the cells of said osteochondral tissue remains viable after said storing compared to the viability of the cells of the osteochondral tissue at day 0.

The foregoing and other aspects of the invention will become more apparent from the following detailed description.

### DETAILED DESCRIPTION

The following definitions and methods are provided to better define the present disclosure and to guide those of ordinary skill in the art in the practice of the present disclosure. Unless otherwise noted, terms are to be understood according to conventional usage by those of ordinary skill in the relevant art.

The present disclosure provides a process for tissue decontamination and preservation. The process includes, in one embodiment, removing viable tissue, such as autograft tissue, from a donor, decontaminating the viable tissue, for example with chlorhexidine, providone-iodine, an iodophor, octenidine dihydrochloride or polyhexanide, and placing the viable tissue into a tissue storage container or bag with a culture medium capable of maintaining the viability and sterility of the tissue, and storing the tissue for extended periods of time prior to implantation into a recipient. Optionally the tissue can be tested of the tissue for infectious diseases and/or mechanical and/or biochemical activity for viability prior to decontamination and/or storage. As used herein, the term “autograft” refers to a tissue graft where the donor and the recipient are the same individual.

Autograft tissue can be removed from a donor by techniques known in the art. For instance, general aseptic surgical methods or other physical intervention of an autograft may include but are not limited to excision, resection, amputation, transplantation, microsurgery, general surgery, laser surgery, robotic surgery, or autopsy, among others.

Tissue or autograft sources may be osteoarticular fracture fragments or tissue from all types of organisms, including, but not limited to human, porcine, ovine, bovine, canine, equine, and others. In one embodiment, the source of the osteoarticular fracture fragments or autograft is human. Although the description herein may refer to autograft tissue, one of skill in the art appreciates that other tissues find use in the method.

Once removed from the donor, the autograft is decontaminated and stored within the tissue storage container or bag for an extended period of time. In one embodiment, the autograft is stored at room temperature in culture media. In specific embodiments, the room temperature is between about 19° C. and 27° C., including about 19° C., 20° C., 21° C., 22° C., 23° C., 24° C., 25° C., 26° C., or about 27° C. In another embodiment, the autograft is stored at a temperature that is not less than about 12° C. and not more than about 30° C.

As used herein, the term “culture media” refers to liquid, semi-solid, or solid media used to support tissue growth and/or preservation and/or development in a non-native environment. Further, by culture media is meant a sterile solution that is capable of stabilizing and preserving the tissue in order to maintain its biological activity and sterility. Suitable tissue culture media are known to one of skill in the art, as discussed in detail subsequently. The media components can be obtained from suppliers other than those identified herein and can be optimized for use by those of skill in the art according to their requirements. Culture media components are well-known to one of skill in the art and concentrations and/or components may be altered as desired or needed. The media-to-tissue ratio within the tissue storage container or bag may be 10-50:1 per volume.

An unexpected benefit of the present procedure is that tissue samples can be decontaminated and maintained viable and sterile for an extended period of time relative to methods of the prior art. For instance, typically in the prior art, upon removal of an autograft from a donor, the tissue was stored on ice or at around 4° C. Tissues prepared according to this method tended to remain suitably viable for around 21-28 days. However, the procedure described herein provides for a surprising and unexpected increase in decontamination and viability of autograft tissue. Tissues prepared, decontaminated and stored according to the procedure described herein remain viable for an extended period of time relative to storage at 4° C. without decontamination. By an extended period is meant at least between about 7-100 days, at least between about 20-80 days, or at least between about 29-70, 40-70, 50-70 or 60-70 days. In one embodiment an extended period is meant up to at least around 70 days.

It has been found that long-term storage of tissue may be facilitated by replacement of old culture medium with fresh, sterile medium. In one embodiment, the media is changed at least once, twice, or three times during storage. The media may be changed, in specific embodiments, about once every other day, at least once a week, at least once every two weeks, or at least about once a month during storage.

Prior to storage according to the present disclosure, testing of autograft tissue encompassed up to or greater than 7 days and required direct contact with the autograft. Such methods increased the likelihood of autograft contamination. The present disclosure provides a convenient and easy method of decontaminating the tissue, and then storing the tissue and testing for viability and/or contamination. The extended storage period allows for examination or testing of the autograft and/or culture media for a number of factors, such as viability, blood type compatibility, HLA typing, genotyping, SNP detection, and/or infection with diseases. Compounds that may be detected or tested may be obtained from culture media withdrawn from the sterile tested such as, but not limited to, bacterial or virus infections, nitric oxide, prostaglandin E₂, matrix metalloproteinase (MMP)-2, MMP-3, MMP-9, and MMP-13, vascular endothelial growth factor (VEGF), interleukin (IL)-2, IL-4, IL-6, IL-7, IL-8, IL-10, IL-15, and IL-18, granulocyte macrophage colony-stimulating factor (GM-CSF), Interferon gamma-induced protein (IP)-10, IFNγ, keratinocyte chemoattractant (KC), MCP-1, and TNFα. Tissue may be tested using methods known in the art, such as by diagnostic PCR or with antibodies against biomarkers such as, but not limited to, those described above. The viability may also be monitored during storage by adding a resazurin solution to the media at a final concentration of about 10 μg/ml and incubated at room temperature for 18-24 hours. During the incubation, resazurin is converted to resorufin by viable cells. A 200 μl sample of the media can be taken and the fluorescence level determined using a fluorescence reader (540-570 nm excitation, 580-610 nm emission). Increased fluorescence is indicative of higher cell viability. Higher viability samples typically have a fluorescence reading of ˜800-1200 units using a Synergy HT set at a sensitivity of 25 on the reader.

In view of the above, the process provides for decontamination and preservation of at least 70% of the osteoarticular fracture fragment tissue after storage at room temperature for 45 days. In an embodiment, at least 60% or 70%, up to at least around 99%, including 60%, 65%, 70%, 75%, 80%, 85%, 90%, or 95% or greater of the tissue is preserved when stored for 45 days, 60 days, or 70 days.

In one embodiment, the process includes decontaminating the tissue, and then storing the tissue in a tissue storage container or bag. In another embodiment, the process further includes implanting the tissue in a subject in need thereof following said storing.

Having now generally described the present disclosure, the same will be more readily understood through reference to the following examples which are provided by way of illustration, and are not intended to be limiting of the present disclosure, unless specified. It should be appreciated by those of skill in the art that the techniques disclosed in the following examples represent techniques discovered by the inventors to function well in the practice of the present disclosure. However, those of skill in the art should, in light of the present disclosure, appreciate that many changes can be made in the specific embodiments that are disclosed and still obtain a like or similar result without departing from the spirit and scope of the present disclosure, therefore all matter set forth or shown in the accompanying drawings is to be interpreted as illustrative and not in a limiting sense.

### EXAMPLES

### Example 1

### Establishing a Novel Preclinical Canine Model for Preservation of Osteochondral Autografts for Delayed Re-Implantation

Open articular fractures represent a complex and challenging issue in orthopedic surgery. These fractures often include osteoarticular fragments that are critical for anatomic and functional restoration of the affected joint, but are contaminated, devascularized, and/or extruded as a result of the inciting trauma. Due to the contamination and soft tissue damage associated with open articular fractures, definitive joint reconstruction is often delayed. Therefore, preservation of critical osteoarticular fragments for subsequent use in surgical reconstruction of the fracture is highly desirable, but no methods have been validated to serve this purpose to-date. This may be due to the challenge of achieving a safe and effective balance between disinfection and maintenance of requisite cell and tissue viability. As such, functional joint reconstruction may not be possible in many of these cases such that subsequent arthroplasty, arthrodesis, or amputation may be necessary. Therefore, a reliable method for disinfection and preservation of osteoarticular fracture fragments for delayed re-implantation (osteochondral autograft) is needed.

Considering recent advances in osteochondral autograft transplantation (OCAT) methods that have resulted in improved outcomes after OCAT in multiple joints, the inventors reasoned that OCA decontamination and preservation protocols could be further developed and optimized in order to safely and effectively preserve osteoarticular fracture fragments from open articular fractures to allow for successful re-implantation in subsequent joint reconstruction surgeries. In order to test this, a valid preclinical animal model that could consistently and reproducibly induce grade 3 open articular fractures with contaminated, devascularized osteoarticular fragments needed to be developed. A canine elbow model for initial development was selected.

In the human elbow, the most common type of open fracture has been reported to be Gustillo-Anderson type 3 (GA3). These fractures result from high-energy trauma and are usually associated with severe soft tissue and bone injuries that include osteoarticular fragments such that they are at high risk for poor outcomes. A significant factor that consistently impacts outcomes for patients who suffer GA3 fractures is loss of functional bone and cartilage for surgical reconstruction of the fractured articular surface(s) due to extrusion, contamination, and/or devascularization of critical osteoarticular fragments. Therefore, a novel preclinical canine model was developed using captive bolt penetrating trauma to the elbow to consistently induce grade 3 open distal humeral articular fractures. The model produced contaminated, devascularized osteoarticular fracture fragments for assessment of clinically relevant decontamination and preservation methods that allow for effective fragment storage for delayed re-implantation for safe and effective functional joint reconstruction.

### Methods

Skeletally mature purpose-bred research hounds (n=9) were humanely euthanized. Immediately following euthanasia, each dog was positioned in sternal recumbency with one forelimb extended and secured in a custom-made positioning apparatus. Fur was not clipped and no aseptic preparation or techniques were implemented. A captive bolt stunner pistol with a 4.75-inch penetrating pin and 1.25 grain cartridge was centered on the cranial (anterior) aspect of the distal humerus, immediately proximal to the joint. With firm pressure against the secured elbow, the pistol was discharged, and the procedure was repeated for the contralateral elbow, creating open fractures in 18 elbows.

After the fractures were induced and radiographs obtained, the skin and soft tissues were aseptically removed. For each elbow, osteoarticular fragments were obtained from the distal humerus, proximal radius, and/or proximal ulna.

For model development, randomly selected osteoarticular fragments (n=24) were immediately placed in 200 ml of Missouri Osteochondral Preservation System (MOPS®) solution (500 ml DMEM, 5 ml ITS (insulin (10 mg/L), transferrin 55 mg/L), selenium (6.7 μg/L)), 5 ml total penicillin (100 U/ml), streptomycin (100 μg/ml), amphotericin B (2.5 μg/ml), 5 ml L-glutamine (2 mM), 5 ml non-essential amino acids (0.1 mM), 1 ml ascorbic acid (50 ng/ml), and 5.46 ml dexamethasone (0.1 μM)) in individual sterile closed containers, transported to the on-site laboratory, and placed in a dedicated storage cabinet in standard room temperature and humidity conditions. At time-0 (n=8) or days 7 (n=8) or 14 (n=8) of storage, osteoarticular fragments were collected and processed for viable chondrocyte density (n=24) and quantitative microbial culture assessments (n=16).

Viable chondrocyte density (VCD) was evaluated using a live-dead calcein AM (live stain) and ethidium homodimer (dead stain) assay, as previously described. (Cook, et al., Am. J. Sports Med. 44:1260-1268, 2016). A minimum of two images from each osteochondral fragment were assessed via fluorescent microscopy. The VCD was determined by counting the number of viable cells in each image and dividing this by the area of the tissue in the image (#of viable cells/area of cartilage tissue mm²). This methodology was aimed at providing an objective and quantifiable assessment of cell viability post-treatment.

In parallel, quantitative microbial cultures were performed on the humerus, radial head, and trochlea of each dog at either 7 or 14 days. Each tissue intended for culture was placed into 18 ml thioglycollate broth and vortexed for 30 seconds. One milliliter of the broth was immediately extracted for the 1:1 dilution and placed in an Eppendorf tube. Serial 1:10 dilutions were made from that subsample and plated within an hour. The plating process comprised 10 μl of each dilution streaked semi-quantitatively onto tryptic soy agar with 5% sheep blood and reduced blood agar. All dilutions were incubated for 72 hours before counting. Additional incubation in the remaining 17 ml thioglycollate for 48 hours was performed, and 10 μl of thioglycollate was re-streaked at that time and incubated for another 72 hours. Organisms were identified via MALDI-TOF or 16S sequencing.

### Results

Captive bolt penetrating trauma resulted in grade 3 open distal humeral articular fracture in each elbow. Untreated controls had high microbial counts, ranging from 5,580,000 to 79,200,000 CFU/specimen of clinically relevant species of Kocuria and Roseomonas. No significant growth of clinically relevant microorganisms was noted for any treated specimen. Chondrocyte viability was similar for humeral, radial, and ulnar articular cartilage within a wide range (˜5-85%) over the two time points. VCD in untreated control articular fragments was significantly higher (p=0.006) than for treated fragments. For both treated and untreated articular fragments, VCD was significantly higher (p<0.001) at day 7 than at day 14.

The current model was able to preserve viable chondrocytes in all autografts for 14 days of storage, maintaining the desired level of 70% chondrocyte viability. Other studies in the literature have reported effective bacterial eradication and safe reimplantation of extruded bone fragments, following treatment of the fragments with irradiation and chemical methods. However, these studies primarily dealt with metaphyseal and diaphyseal fragments, thus not addressing the need to preserve articular cartilage, a tissue more sensitive to these types of treatments.

The innovative preclinical canine model employing captive bolt penetrating trauma to the elbow has been validated for its consistent ability to induce contaminated, grade 3 open fractures in the distal humeral articulation. This open fracture model plays a crucial role in facilitating the development of a standardized clinical decontamination protocol, designed to enable the safe reimplantation of extruded osteochondral fragments (see Examples below). This protocol effectively eradicates pathogenic microbial growth during the osteochondral autograft storage period, while maintaining chondrocyte viability.

This preclinical study validates the feasibility of the described canine model, which successfully induced grade 3 open fractures in each involved elbow, resulting in infection in 100% of cases when left untreated. These data show that contaminated, devascularized, extruded articular fracture fragments can be retained, stored, and used as osteochondral autografts for subsequent anatomic and functional elbow joint reconstruction.

### Example 2

### Additional Studies on a Preclinical Canine Model for Preservation of Osteochondral Autografts for Delayed Re-Implantation

Open fractures of the elbow present a complex and challenging orthopedic management problem. The most severe type, grade 3 open elbow fracture, is most common (43%) and is associated with profound morbidity. One of the factors that influences outcomes for patients suffering these fractures is loss of functional bone for surgical reconstruction of the fractured humerus, radius, and/or ulna as a result of the trauma. The patient's bone is often grossly contaminated, devascularized, and/or extruded. As such, multiple staged surgeries with extensive bone grafting and/or subsequent arthroplasty, arthrodesis, or amputation may be necessary. Retention of contaminated, devascularized, or extruded bone to allow for anatomic and functional elbow joint reconstruction is highly desirable, yet has rarely been consistently successful using current methods. The lack of success may be related to the difficulty in achieving a safe and effective balance between disinfection and preservation of cell and tissue viability, especially when articular cartilage is included in the needed fragments. Based on recent advances in osteochondral allograft (OCA) preservation that have resulted in improved outcomes after OCA transplantation in multiple joints, the potential for OCA preservation methods was investigated to allow for effective treatment and storage of osteochondral fragments recovered from open elbow fractures such that delayed re-implantation (osteochondral autograft) for functional reconstruction of the elbow could be considered. Therefore, the present study was designed to test 1) a novel preclinical canine model employing captive bolt penetrating trauma to the elbow to consistently induce grade 3 open distal humeral articular fractures, and 2) disinfection followed by storage using an OCA preservation system to allow for effective decontamination and retention of sufficient (70%) viable chondrocyte density in osteochondral fracture fragments for up to 14 days after recovery.

### Methods

Skeletally mature purpose-bred research hounds (n=8) were humanely euthanatized for purposes unrelated to the present study. Immediately after euthanasia, each dog was positioned in sternal recumbency with one forelimb extended and secured in a custom-made holding apparatus. A captive bolt stunner pistol with 4.75 inch penetrating pin and 1.25 grain cartridge was centered on the cranial (anterior) aspect of the distal humerus immediately proximal to the joint. With firm pressure against the secured elbow, the pistol was discharged. The procedure was then repeated for the contralateral elbow (n=16 elbows). Skin and soft tissues were aseptically removed, and the distal humerus (n=16), proximal radius (n=16), and proximal ulna (n=16) were osteotomized and processed under operating room conditions. For 14 elbows, each osteochondral fragment was thoroughly irrigated with 1 L of sterile 0.9% saline, immersed in 10% povidone-iodine solution for 20 minutes, and thoroughly irrigated again with 1 L of sterile 0.9% saline. Osteochondral fragments (n=6) from two randomly selected elbows were not treated after recovery in order to serve as untreated controls.

Each osteochondral fragment was placed in 200 ml of Missouri Osteochondral Preservation System (MOPS®) solution in individual sterile closed containers, transported to the onsite laboratory, and placed in a dedicated storage cabinet in standard room temperature and humidity conditions. After 7 (n=24) or 14 (n=24) days in storage, osteochondral fragments were collected and processed for viable cell density and quantitative microbial culture assessments.

Viable chondrocyte density (VCD) was evaluated using a live-dead calcein AM (live stain) and ethidium homodimer (dead stain) assay. At least 2 images from each osteochondral fragment were assessed via fluorescent microscopy. VCD was determined by counting the number of viable cells in each image divided by the area of the tissue in the image (#of viable cells/area of cartilage tissue mm²).

Quantitative microbial cultures were performed on humerus (n=8), radial head (n=8), and trochlea, (n=8) of each dog at days 7 or 14. Each tissue for culture was placed into 18 ml thioglycollate broth and vortexed for 30 seconds. One milliliter of broth was immediately extracted for the 1:1 dilution and placed in an Eppendorf tube. Serial 1:10 dilutions were made from that subsample and plated within 1 hour. Plating comprised 10 μl of each dilution streaked semi quantitatively onto tryptic soy agar with 5% sheep blood and reduced blood agar. All dilutions were incubated for 72 h prior to being counted. All bone specimens were additionally incubated in the 17 ml thioglycollate for 48 h and 10 μl of thioglycollate was re-streaked at that time and incubated for an additional 72 h. Organisms were identified via MALDI-TOF or 16S sequencing.

### Results

Captive bolt penetrating trauma resulted in grade 3 open distal humeral articular fracture in each elbow. Untreated controls had high microbial counts, ranging from 5,580,000 to 79,200,000 CFU/specimen of clinically relevant species of Kocuria and Roseomonas. No significant growth of clinically relevant microorganisms was noted for any treated specimen.

Chondrocyte viability was similar for humeral, radial, and ulnar articular cartilage within a wide range (˜5-85%) over the two time points. VCD in untreated control articular fragments was significantly higher (p=0.006) than for treated fragments. For both treated and untreated articular fragments, VCD was significantly higher (p<0.001) at day 7 than at day 14.

A novel preclinical canine model employing captive bolt penetrating trauma to the elbow was validated for the ability to consistently induce grade 3 open, contaminated, distal humeral articular fractures. A standard clinical decontamination protocol consisting of saline irrigation, 10% povidone-iodine solution immersion, and repeated saline irrigation was successful in eliminating pathologic microbial growth for 14 days of osteochondral autograft storage. Taken together, these data suggest that contaminated, devascularized, extruded articular fracture fragments can be retained, stored, and used as osteochondral autografts to allow for subsequent anatomic and functional elbow joint reconstruction. To optimize a safe and effective balance between disinfection and preservation of cell and tissue viability, additional decontamination protocols that favor maintenance of cell viability were studied using this model.

### Example 3

### Decontamination and Preservation of Extruded Osteoarticular Fracture Fragments for Delayed Surgical Re-Implantation

Open articular fractures pose a challenge for orthopedic surgeons. Anatomic reconstruction with autogenous cartilage and bone provides the most consistently successful outcomes; therefore, retention of osteoarticular fracture fragments is desirable. However, these fragments are often contaminated, devascularized, and/or extruded, making standard methods for preservation and reimplantation rarely successful. Current recommendations, therefore, are to discard osteoarticular fracture fragments. This lack of success may be related to difficulty in achieving a safe and effective balance between disinfection and preservation of viability.

With recent advances in osteochondral allograft (OCA) preservation and transplantation in multiple joints, the inventors investigated the potential for OCA preservation methods for effective disinfection and storage of osteoarticular fracture fragments such that delayed re-implantation for functional joint reconstruction could be considered. Using a preclinical captive bolt penetrating trauma model (Example 1, above), this study was designed to show that disinfection followed by storage using the Missouri Osteochondral Preservation System (MOPS®) allows for effective decontamination while retaining viable chondrocytes in extruded osteoarticular fracture fragments for up to 14 days after recovery.

### Methods

Purpose-bred hounds (n=16) were humanely euthanized, immediately after which an open articular fracture in both elbows (n=32) was created using a captive bolt pistol. Each dog was positioned in sternal recumbency with one forelimb extended and secured in a custom made positioning apparatus. Fur was not clipped and no aseptic preparation or techniques were implemented. A captive bolt stunner pistol with a 4.75-inch penetrating pin and 1.25 grain cartridge was centered on the cranial (anterior) aspect of the distal humerus, immediately proximal to the joint. With firm pressure against the secured elbow, the pistol was discharged, and the procedure was repeated for the contralateral elbow. Soft tissues were removed aseptically and the distal humerus (n=32), proximal radius (n=32), and trochlea (n=32) were osteotomized and processed under operating room conditions in 1 of 3 ways: 1) Betadine (n=40): 0.9% saline irrigation (1 L), 10% povidone-iodine solution immersion (20 min), saline irrigation; 2) Chlorhexidine (n=42): saline irrigation, 0.002% chlorhexidine solution immersion (20 min), saline irrigation; 3) Control (n=12): untreated. Each osteoarticular fragment was placed in 200 ml of MOPS® solution (500 ml DMEM, 5 ml ITS (insulin (10 mg/L), transferrin 55 mg/L), selenium (6.7 μg/L)), 5 ml total penicillin (100 U/ml), streptomycin (100 μg/ml), amphotericin B (2.5 μg/ml), 5 ml L-glutamine (2 mM), 5 ml non-essential amino acids (0.1 mM), 1 ml ascorbic acid (50 ng/ml), and 5.46 ml dexamethasone (0.1 μM)) in a sterile container and stored under standard room temperature and humidity conditions for 7 (n=46) or 14 (n=48) days. At each time point, viable chondrocyte density (VCD) and quantitative microbial culture assessments were assayed, yielding a count of colony forming units (CFU) per specimen.

Viable chondrocyte density (VCD) was evaluated using a live-dead calcein AM (live stain) and ethidium homodimer (dead stain) assay, as previously described (Cook, et al., Am. J. Sports Med. 44:1260-1268, 2016). A minimum of two images from each osteochondral fragment were assessed via fluorescent microscopy. The VCD was determined by counting the number of viable cells in each image and dividing this by the area of the tissue in the image (#of viable cells/area of cartilage tissue mm²). This methodology was aimed at providing an objective and quantifiable assessment of cell viability post-treatment.

In parallel, quantitative microbial cultures were performed on the humerus, radial head, and trochlea of each dog at either 7 or 14 days. Each tissue intended for culture was placed into 18 ml thioglycollate broth and vortexed for 30 seconds. One milliliter of the broth was immediately extracted for the 1:1 dilution and placed in an Eppendorf tube. Serial 1:10 dilutions were made from that subsample and plated within an hour. The plating process comprised 10 μl of each dilution streaked semi-quantitatively onto tryptic soy agar with 5% sheep blood and reduced blood agar. All dilutions were incubated for 72 hours before counting. Additional incubation in the remaining 17 ml thioglycollate for 48 hours was performed, and 10 μl of thioglycollate was re-streaked at that time and incubated for another 72 hours. Organisms were identified via MALDI-TOF or 16S sequencing.

Univariate comparison of VCD and CFU were performed via Kruskal-Wallis and Chi-squared test. Multivariate linear regression was used, controlling for osteotomy site and storage time, to determine the correlation between processing method and VCD or CFU. Data manipulation and statistical analysis were performed using R software.

### Results

Captive bolt penetrating trauma achieved Gustilo-Anderson type III open distal humeral, proximal radial and trochlear fractures in each elbow. Control, Betadine, and Chlorhexidine treatment resulted in differing distribution of VCD and CFU per specimen at 7 and 14 days on univariate analysis (Table 1). At 7 days, mean VCD was 603 for controls, 293 for betadine and 772 for chlorhexidine (p<0.001). At 14 days, mean VCD was 125 for controls, 62 for betadine and 710 for chlorhexidine (p<0.001). At 7 days, mean CFU was 19.8 for controls, 0.2 for betadine and 0.4 for chlorhexidine (p<0.001). At 14 days, mean CFU was 20.1 for controls, 3.3 for betadine and 7.9 for chlorhexidine (p=0.003).

TABLE 1

| Storage | | | | | | |
|---|---|---|---|---|---|---|
| time, | | Control | Betadine | Chlorhexidine | Total | p |
| days | | (N = 12) | (N = 40) | (N = 42) | (N = 94) | value |
| 7 | Location, n | | | | | 0.992 |
| | (%) | | | | | |
| | Distal | 2 (33.3%) | 7 (36.8%) | 7 (33.3%) | 16 (34.8%) | |
| | Humerus | | | | | |
| | Radial Head | 2 (33.3%) | 7 (36.8%) | 7 (33.3%) | 16 (34.8%) | |
| | Trochlea | 2 (33.3%) | 5 (26.3%) | 7 (33.3%) | 14 (30.4%) | |
| | Viable | 603.0 | 293.2 | 772.3 (257.0) | 552.3 | <0.001 |
| | Chondrocyte | (280.4) | (184.1) | | (320.8) | |
| | Density, | | | | | |
| | mean (SD), | | | | | |
| | mm⁻² | | | | | |
| | Colony | 19.8 (29.8) | 0.2 (0.5) | 0.4 (1.8) | 2.9 (12.1) | <0.001 |
| | Forming | | | | | |
| | Units, mean | | | | | |
| | (SD), 10⁶ per | | | | | |
| | specimen | | | | | |
| 14 | Location, n | | | | | 1.000 |
| | (%) | | | | | |
| | Distal | 2 (33.3%) | 7 (33.3%) | 7 (33.3%) | 16 (33.3%) | |
| | Humerus | | | | | |
| | Radial Head | 2 (33.3%) | 7 (33.3%) | 7 (33.3%) | 16 (33.3%) | |
| | Trochlea | 2 (33.3%) | 7 (33.3%) | 7 (33.3%) | 16 (33.3%) | |
| | Viable | 125.2 | 62.3 (71.5) | 709.5 (338.0) | 353.3 | <0.001 |
| | Chondrocyte | (117.9) | | | (391.7) | |
| | Density, | | | | | |
| | mean (SD), | | | | | |
| | mm⁻² | | | | | |
| | Colony | 20.1 (16.9) | 3.3 (6.7) | 7.9 (14.2) | 7.4 (12.8) | 0.003 |
| | Forming | | | | | |
| | Units, mean | | | | | |
| | (SD), 10⁶ per | | | | | |
| | specimen | | | | | |

On multivariate analysis with independent variables of treatment group, storage timing, and osteotomy site, treatment with betadine correlated with a decrease of 187 VCD (p=0.02) relative to control treatment and treatment with chlorhexidine correlated with an increase of 377 VCD (p<0.001) relative to control treatment. When controlling for osteotomy site and storage timing, treatment with betadine correlated with a decrease of 18.4×10⁶ CFU (p<0.001) relative to control treatment and treatment with chlorhexidine correlated with a decrease of 15.8×10⁶ CFU (p<0.001) relative to control treatment. 14 days of storage correlated with a decrease of 187 VCD relative to 7 days of storage (p<0.001) and an increase of 4.8×10⁶ CFU at 14 days of storage relative to 7 days of storage when controlling for treatment group and osteotomy site.

A treatment protocol combining saline irrigation with 0.002% chlorhexidine immersion followed by room temperature storage in MOPS® was effective for decontaminating osteoarticular fracture fragments while maintaining chondrocyte viability for up to 14 days after penetrating trauma. This study demonstrates that contaminated, devascularized, extruded articular fracture fragments can be retained and stored for use as osteoarticular autografts such that delayed re-implantation for functional joint reconstruction can be considered.

### Example 4

### In Vivo Study of Decontamination and Preservation of Extruded Osteoarticular Fracture Fragments and Surgical Re-Implantation

A grade 3 open femoral bicondylar fracture was created in 3 canines. A lateral parapatellar approach was used, the fragment was cultured and retrieved. The fragment was irrigated, treated with 0.002% chlorhexidine for 20 minutes, irrigated, and stored in MOPS® for 7 days, after which the fragment was reimplanted, and both condyles were repaired with 3.5 mm cannulated lag screws. After 3 months, quantitative bacterial cultures (CFU/g; Table 2) and functional outcomes (Table 3) were measured.

TABLE 2

| | Initial Trauma | Reimplantation | | Endpoint | |
|---|---|---|---|---|---|
| | Fracture | | MOPS ® | | Fracture |
| Dog | Fragment | Synovium | Media | Synovium | Fragment |
| | 355 | 0 | 0 | 0 | 0 |
| | 0 | 0 | 0 | 0 | 0 |
| | 41 | 119 | 0 | 0 | 0 |

TABLE 3

| | Function (VAS) | | Pain (VAS) | | ROM (degrees) | |
|---|---|---|---|---|---|---|
| Dog | Pre | Post | Post | Pre | Pre | Post |
| 1 | 10 | 9 | 0 | 1.2 | 108 | 101 |
| 2 | 10 | 8.8 | 0 | 1.9 | 107 | 97 |
| 3 | 10 | 9.3 | 0 | 0.6 | 109 | 104 |

A treatment protocol combining saline irrigation with 0.002% chlorhexidine immersion followed by shelf-stable (room temperature) point-of-care storage in MOPS® was effective for decontaminating devascularized, contaminated, extruded osteoarticular fracture fragments while maintaining chondrocyte viability for 14 days after penetrating trauma resulting in type 3 open articular fractures. Contaminated, devascularized, extruded articular fracture fragments can be retained, stored, and used as osteoarticular autografts for subsequent joint reconstruction.

### Example 5

### Comparison of Decontamination-Preservation Protocols for Delayed Surgical Re-Implantation of Osteoarticular Fracture Fragments

For open articular fractures, anatomic osteoarticular reconstruction is associated with the most optimal restoration of function such that retention of osteoarticular fracture fragments is desirable. However, these fragments are often contaminated, devascularized and/or extruded, making immediate reimplantation rarely successful and potentially detrimental to joint health, such that these fragments are often discarded. In these cases, the remaining treatment options include delayed arthroplasty, arthrodesis or amputation. To avoid the need to discard osteoarticular fragments required for safe and effective anatomic osteoarticular reconstruction, the fragments need to be decontaminated while preserving chondrocyte viability and tissue integrity for delayed reimplantation as an osteochondral autograft.

Studies examining methods for retention and reimplantation of osteoarticular fracture fragments for joint reconstruction have not yet validated a safe and effective process for clinical use. In a rat model, large osteoarticular segments were successfully reimplanted after sterilization using a combination of povidone-iodine scrub with autoclaving or antibiotic solution immersion to reconstruct open femur fractures. While this method was highly effective for decontamination and preservation of articular surface morphology, chondrocyte viability and the related effects on joint health and function were not assessed. Another study showed that immediate intraoperative treatment of potentially contaminated human femoral osteochondral allografts using 0.002% Chlorhexidine Gluconate (CHG) resulted in effective decontamination while preserving chondrocyte viability for up to 7 days. However, this process has not been validated for decontamination and preservation of osteoarticular fracture fragments. As such, these methods need to be tested in a relevant preclinical open articular fracture model to develop and validate a protocol that optimizes the balance between decontamination and preservation of chondrocyte viability for point-of-care storage and reimplantation of contaminated, devascularized and/or extruded osteoarticular fragments. For translation to safe and effective clinical use, the goals for decontamination and preservation of osteoarticular fracture fragments were to achieve complete clearance of bacteria and maintain at least 70% of the Viable Chondrocyte Density (VCD) of healthy articular cartilage for a minimum of 7 days in storage.

Recent advances in shelf-stable Osteochondral Allograft (OCA) preservation have resulted in significant improvements in OCA transplantation outcomes. The potential for similar methods to be coupled with validated tissue disinfection protocols for effective decontamination and point-of-care storage of osteoarticular fracture fragments such that delayed re-implantation for functional joint reconstruction could be considered was studied. Using a preclinical canine model, this study was designed to test if disinfection with povidone-iodine or chlorhexidine followed by storage using the Missouri Osteochondral Preservation System (MOPS®) would allow for effective decontamination while retaining minimum essential viable chondrocyte density in osteoarticular fracture fragments for up to 14 days of shelf-stable point-of-care preservation for delayed re-implantation.

### Methods

Skeletally mature purpose-bred research hounds (n=16) were humanely euthanized for purposes unrelated to the present study. Immediately following euthanasia, each dog was positioned in sternal recumbency with one forelimb extended and secured in a custom-made positioning apparatus. Fur was not clipped and no aseptic preparation or decontamination techniques were performed. Using a validated technique, a penetrating captive bolt stunner pistol (CASH Special, FRONTMATEC, Birmingham, United Kingdom) with a 1.25 grain cartridge was centered on the cranial (anterior) aspect of the distal humerus, immediately proximal to the elbow joint and with firm pressure against the secured elbow, the pistol was discharged, creating type 3 open distal humeral fractures. After the fractures were induced and radiographs obtained, the skin and soft tissues were aseptically removed. For each elbow (n=32), osteoarticular tissues were obtained from the distal humerus, proximal radius and proximal ulna such that 96 contaminated, devascularized, osteoarticular fracture fragments were randomly allocated to undergo treatment using one of the following protocols for comparison: 1)⋅Betadine (n=42): bulb irrigation using 1 L of 0.9% saline, followed by immersion in 10% povidone-iodine solution for 20 min, followed by bulb irrigation using 1 L of 0.9% saline; 2)⋅Chlorhexidine (n=42): bulb irrigation using 1 L of 0.9% saline, followed by immersion in 0.002% chlorhexidine gluconate solution immersion for 20 min, followed by bulb irrigation using 1 L of 0.9% saline; and 3)⋅Injured Control (n=12): no decontamination treatment. Each fragment was then immediately placed in 200 ml of Missouri Osteochondral Preservation System (MOPS®) solution in individual sterile closed containers, transported to the on-site laboratory and placed in a dedicated storage cabinet in standard room temperature and humidity conditions for 7 or 14 days.

Viable Chondrocyte Density. At days 7 (n=21) or 14 (n=21) of storage, osteoarticular tissues were collected and processed for assessment of viable chondrocyte density (VCD). VCD was assessed using a live-dead assay involving calcein AM (live stain) and ethidium homodimer (dead stain). Briefly, tissues were sagittally sectioned using a Buchler Isomet low speed saw (Lake Bluff, IL, USA) to produce representative 1 mm-thick sections from each. Sections were placed in 6-well plates containing calcein AM (1 μg/ml) solution and ethidium homodimer (1 μM) in Phosphate Buffered Saline (PBS). The plates were incubated for 30 minutes at 37° C. After incubation, the stain was removed, the samples rinsed in PBS and tissues were mounted to the bottom of the plate using a 4% agarose solution. Fluorescent microscopy was used to obtain two images per section, which were analyzed to quantify tissue viability based on VCD. The VCD was determined by counting the number of viable cells in each image and dividing this by the area of the tissue in the image (#of viable cells/area of cartilage tissue mm²). The percentage of viable chondrocyte density (% VCD) for each fracture fragment was calculated based on the mean VCD of healthy day-0 samples using the formula: (fractured VCD/control VCD)×100.

Microbial Cultures. At days 7 (n=21) or 14 (n=21) of storage, osteoarticular fracture fragments were also collected and processed for quantitative microbial culture. Each tissue intended for culture was placed into 18 ml thioglycollate broth and vortexed for 30 seconds, as effective aseptic grinding of bone specimens was not possible. One milliliter of the broth was immediately extracted for the 1:1 dilution and placed in an Eppendorf tube. Serial 1:10 dilutions were made from that subsample and plated within an hour. The plating process comprised 10 μl of each dilution streaked onto tryptic soy agar with 5% sheep blood for aerobic culture and pre-reduced tryptic soy agar with 5% sheep blood for anaerobic culture. All dilutions were incubated for 72 h under appropriate conditions before counting. Additional incubation in the 17 ml thioglycollate for 48 h was performed and 10 μl of thioglycollate was re-streaked at that time and incubated for another 72 h. Organisms were identified via MALDI-TOF or 16S rRNA sequencing. Microorganism cultures were quantified using Colony-Forming Unit (CFU) counts per milliliter of broth. This method involved preparing a series of dilutions from the original sample to ensure countable colony growth on the Petri dish. Ten microliters of the sample were inoculated onto agar plates that were incubated under appropriate conditions to allow for the microorganisms' growth. Post incubation, the number of colonies formed on each plate was counted. The number of CFUs per milliliter (CFU/ml) was calculated using the formula: CFU/ml=(number of colonies×dilution factor)/volume inoculated. The CFU/ml data were reported as mean and range per specimen, providing both the typical value and variability in the microbial populations within the samples.

Statistical Analysis. All data were analyzed using statistical software R Studio, version 4.3.1 (Posit Software, Boston, MA, USA). Descriptive statistics for VCD, % VCD and CFU were calculated to report means, standard deviations, ranges and percentages. Differences in % VCD at each time point were compared among treatments using one-way ANOVA tests. Differences in % VCD over time in the Injured Control group were compared using one-way repeated measures ANOVA. Statistical significance was set at p<0.05.

### Results

The captive bolt penetrating trauma consistently resulted in type 3 open distal humeral articular fractures in each elbow of the canine cadavers. Injured Control osteoarticular fragments produced high polymicrobial counts with a mean of 19,818,000 CFU/specimen (range, 1,098,000 to 79,200,000 CFU/specimen) at day 7 and mean of 20,070,000 CFU/specimen (range, 7,740,000 to 50,400,000 CFU/specimen) at day 14. As such, tissues collected were representative of contaminated, devascularized, extruded osteoarticular fragments from type 3 open fractures.

Decontamination Protocols. Chlorhexidine treatment was effective at decontamination of osteoarticular tissues based on quantitative microbial tissue cultures on days 7 and 14. No CFUs for clinically relevant bacterial species were produced at either time point. Betadine treatment was not fully effective at decontamination of osteoarticular tissues based on two (10%) osteoarticular tissues producing Roseomonas sp and one (5%) producing Methylobacterium sp CFUs at day 7 and six (29%) osteoarticular tissues producing Methylobacterium sp CFUs at day 14.

Viable Chondrocyte Density. Results of VCD are shown in Table 4. Trauma from captive bolt fracture creation was associated with a decrease in chondrocyte viability such that day-0 mean % VCD in Injured Control osteoarticular fragments was 91.7% of anatomically matched healthy (uninjured) day-0 tissues. Mean % VCD further significantly decreased in Injured Control osteoarticular fragments assessed on days 7 (p<0.001) and 14 (p<0.001). On days 7 and 14, % VCD for the Chlorhexidine group was significantly (p<0.001) higher than for the Betadine and Injured Control groups with the mean exceeding the minimum essential threshold of 70%. Interestingly, % VCD for the Betadine group was notably lower than for the Injured Control group, suggesting that 20-minute 10% povidone-iodine immersion was associated with additional cytotoxicity during storage of the osteoarticular fracture fragments.

TABLE 4

| | Day 0 | Day 7 | Day 14 |
|---|---|---|---|
| Injured Controls | 91.7 ± 12.1 | 59.3 ± 26.2 | 12.7 ± 12.3 |
| Betadine | | 29.2 ± 18.6 | 6.4 ± 7.4 |
| Chlorhexidine | | 75.7 ± 24.2 | 70.1 ± 24.1 |

A protocol combining saline irrigation with 0.002% chlorhexidine gluconate immersion for 20 minutes followed by shelf-stable point-of-care storage in MOPS® was effective for decontaminating extruded, devascularized osteoarticular fracture fragments while maintaining minimum essential chondrocyte viability for up to 14 days after type 3 open articular fractures of the elbow in a preclinical canine model. Importantly, saline-chlorhexidine decontamination followed by shelf-stable point-of-care MOPS® preservation maintained VCD in the osteoarticular tissues over the desired 70% mean for the entire study period, whereas the trauma alone was associated with significant loss of VCD (Day-7=59%, Day-14=13%), which was further exacerbated by povidone-iodine treatment (Day-7=29%, Day-14=6%). Compared to the protocol combining saline irrigation with 10% povidone-iodine immersion, the chlorhexidine protocol was superior for decontamination and for preservation of cell viability, suggesting a chondroprotective effect associated with the combination of chlorhexidine decontamination and MOPS® preservation. As chlorhexidine is available and used routinely in surgical settings, the results of the present study suggest that the saline-chlorhexidine-MOPS® decontamination-preservation protocol allows for contaminated, devascularized and/or extruded osteoarticular fracture fragments to be safely and effectively recovered, treated, stored and reimplanted during subsequent joint reconstruction surgeries.

Previous studies validated the use of chlorhexidine solution to effectively reduce bacterial burden of grossly contaminated bone segments based on 20-minute immersion in 2% chlorhexidine removing >99% of a Staphylococcus aureus burden. However, it was reported that decontamination with 2% chlorhexidine gluconate was associated with complete loss of cell viability in bone such that it was not recommended for applications that required preservation of viable cells. The effects of 10% povidone-iodine and 0.4% chlorhexidine 20-minute immersion on contaminated osteochondral tissues was previously evaluated in a rabbit model; both solutions were effective at fully decontaminating these tissues but the effects on chondrocyte viability were not determined. The effects of various concentrations of chlorhexidine on human chondrocyte viability after treatment of contaminated osteochondral allografts was previous evaluated, and showed that pulse lavage using 0.002% chlorhexidine gluconate (1 L) was effective for complete decontamination and was able to maintain chondrocyte viability at day-0 level for 7 days in tissue culture. Higher concentrations of CHG were associated with significant chondrocyte viability loss within 24 hours of treatment. The results of the present study provide further evidence for the use of 0.002% CHG (20-minute immersion) for osteoarticular tissue decontamination and use of MOPS® for preserving minimum essential chondrocyte viability during shelf-stable point-of-care storage. Importantly, the decontamination-preservation protocol used in the present study did not require tissue culture and was effective in preserving VCD for 14 days after recovery and treatment of contaminated osteoarticular tissues. Seven days was selected for the minimum preservation period needed for clinical applicability based on typical time frames for definitive joint reconstruction surgeries following articular fractures initially managed with temporary stabilization; the capabilities for preserving the tissues for an additional 7 days verify clinical feasibility for use of this method in standard-of-care patient management and fracture treatment and entail important advantages for patient and wound optimization, timing and resource allocation.

The data from this preclinical animal model study verify that contaminated, devascularized, extruded osteoarticular fracture fragments can be effectively decontaminated while maintaining minimum essential chondrocyte viability for up to 14 days after type 3 open articular fractures using a decontamination-preservation protocol that combines saline irrigation with 0.002% chlorhexidine immersion followed by shelf-stable point-of-care storage in MOPS®. These data provide the evidence for this decontamination-preservation protocol to be applied to clinical care by allowing for osteoarticular fracture fragments to not be discarded, but rather safely and effectively preserved during initial patient and wound management steps such that they can be reimplanted during subsequent joint reconstruction surgeries that result in functional joint and limb preservation.

What is claimed is:

1. A process for decontamination and preservation of osteochondral tissue comprising contacting the osteochondral tissue with chlorhexidine and then storing the osteochondral tissue at room temperature in a container comprising serum-free culture medium for from at least 7 to 70 days prior to implantation, wherein at least 70% of the cells of said osteochondral tissue remains viable after said storing compared to the viability of the cells of the osteochondral tissue at day 0.

2. The process of claim 1, wherein the osteochondral tissue is an osteoarticular fracture fragment, meniscus, meniscal tissue, cartilage or other component of a joint or bone tissue fragment.

3. The process of claim 1, comprising testing the osteochondral tissue for viability at least once prior to implantation in a patient.

4. The process of claim 3, wherein testing for viability comprises assaying the medium withdrawn from said container.

5. The process of claim 3, wherein testing for viability comprises adding a resazurin solution to the medium and determining the fluorescence level, wherein increased fluorescence indicates higher cell viability.

6. The process of claim 1 comprising changing said medium at least once during the storing.

7. The process of claim 6, comprising changing the medium about once every two weeks during the storing.

8. The process of claim 1, wherein the medium comprises Dulbecco's Modified Eagle Medium (DMEM), insulin, transferrin, selenium, at least a first antibiotic compound, at least a first antimycotic compound, L-glutamine, non-essential amino acids, ascorbic acid, and dexamethasone.

9. The process of claim 8, wherein the at least a first antibiotic compound comprises penicillin and streptomycin.

10. The process of claim 8, wherein the at least a first antimycotic compound is amphotericin B.

11. The process of claim 1, wherein the osteochondral tissue is from a humerus, radius, ulna, femur, tibia, fibula, spine, scapula, pelvis, patella, talus, phalanges or temporomandibular joint.

12. The process of claim 1, wherein the osteochondral tissue comprises an autograft.

13. The process of claim 1, wherein the osteochondral tissue comprises an autograft, the process further comprising lavaging of the osteoarticular fracture fragments in isotonic solution prior to said storing.

14. The process of claim 1, further comprising implanting the osteochondral tissue in a subject in need thereof following said storing.

15. The process of claim 1, wherein the room temperature is between about 19° C. and 27° C.

16. The process of claim 1, wherein the room temperature is about 19° C., 20° C., 21° C., 22° C., 23° C., 24° C., 25° C., 26° C., or about 26° C.

17. The method of claim 1, wherein the osteochondral tissue is contacted with chlorhexidine for between about 5 minutes and about 60 minutes.

18. The method of claim 17, wherein the osteochondral tissue is contacted with chlorhexidine for about 20 minutes.

19. The method of claim 1, wherein the osteochondral tissue is contacted with about 0.002% chlorhexidine.

20. A method for decontaminating and preserving osteochondral tissue, comprising contacting the osteochondral tissue with chlorhexidine, and placing the osteochondral tissue in a tissue storage container or bag with said medium; and storing the osteochondral tissue at room temperature for at least 7 to 70 days prior to implantation, wherein at least 70% of the cells of said osteochondral tissue remains viable after said storing compared to the viability of the cells of the osteochondral tissue at day 0.

21. The method of claim 20, wherein the osteochondral tissue is an osteoarticular fracture fragment, meniscus, meniscal tissue, cartilage or other component of a joint or bone tissue fragment.
